(19) United States
(12) Patent Application Publication
(10) Pub. No.: US 2009/0181571 A1
(43) Pub. Date: Jul. 16, 2009

(54) SEALED CARTRIDGE ELECTRICAL INTERCONNECT

(75) Inventors: Steven Lee WILLING, Encinitas, CA (US); Larry F. UTT, Mishawaka, IN (US); Kent CARLSON, Allentown, PA (US)

Correspondence Address: CHARLES N. QUINN;FOX ROTHSCHILD LLP, 2000 MARKET STREET, 10TH FLOOR, PHILADELPHIA, PA, 19103, US

(73) Assignee: PEI/Genesis, Inc., Philadelphia, PA (US)

(21) Appl. No.: 12/196,437

(22) Filed: Aug. 22, 2008

Related U.S. Application Data
(63) Continuation-in-part of application No. 11/053,579, filed on Feb. 8, 2005.
(60) Provisional application No. 60/543,426, filed on Feb. 9, 2004.

(51) Int. Cl. H01R 13/627

(52) U.S. Cl. 439/359

(57) ABSTRACT

A sealed cover and plastic cartridge combination for electrical connections providing sealing, strain relief, mechanical retention, electrical insulation and flex relief similar to that achieved using an over-molded design includes a plastic cartridge of integral construction or composed of two or more parts, in either case housing one or more contacts of the connections.

### CROSS-REFERENCE TO RELATED PATENT APPLICATION

The present patent application is a continuation-in-part of U.S. patent application Ser. No. 11/053,579, which claims the benefit under 35 USC 119 and 120 of the filing date and priority of provisional U.S. patent application Ser. No. 60/543,426, filed 9 Feb. 2004.

### FIELD OF THE INVENTION

The present invention relates to an apparatus and method for protecting the electrical connections within an electrical cable. More specifically, the present invention is a cable assembly comprised of a plug and a receptacle. Both the plug and the receptacle are each comprised of a sealing cover and a plurality of cartridges contained therein. The cartridges are adapted to retain one or more electrical contacts such that, when the plug is connected with the receptacle, the contacts place the plug into electrical communication with the receptacle.

### Background of the Invention-Description of the Prior Art

Electronic cables remain ubiquitous as a necessity for powering and/or assisting in the passage of electronic data or information. At their core, many electronic cables are comprised of one or more wires electrically communicated with at least one contact. The contact is usually receivable by a corresponding port or receptacle. In many instances, it is imperative that the contact be received by the receptacle without interference such that the electrical flow along the connection remains uninterrupted. To this end, the contact should be adapted to be received by the receptacle so as to maintain the electrical connection without allowing environmental elements to interfere with or even break this connection.

Over molding is one known solution used in the art for protecting electrical cables. The term “molding” is used to refer to an electrical connector having a molded connector body housing the contacts, which are connected to one or more electrical wires. Referring to FIGS. 6, 7, and 8, a typical over molded electrical cable assembly is illustrated as comprising one or more wire strands 106, at least one contact 102, a pre-mold 110, and an over mold 112. The contact 102 is illustrated as a rod-like element, preferably comprised of a electrically conductive material. The contact 102 is rounded at one end forming a male end of the cable that is adapted to electrically communicate with a corresponding female port or receptacle (not illustrated).

A pair of receivers 104 extend from the opposing end of the contact. The receivers 104 are aligned to receive one or more wire strands 106 extending from a jacketed portion 107 of an insulated wire 108. The receivers 104 are usually crimped or soldered to wire strands 106 so as to mechanically retain the wire strands 106 and effectuate good electrical conductivity between the wire strands 106 and the receivers 104. Ultimately, the connection between the receivers 104 and the wire strands 106 places the contact 102 into electrical communication with the wires.

Once the wire strands 106 are coupled to the receivers 104, the wire and contact sub assembly goes through a molding process known as a “pre-mold,” illustrated by reference numeral 110. More specifically, a pre-mold is typically a pre-formed sleeve comprised of a rigid material, usually a thermoplastic such as nylon, to encapsulate the wire 108 and receivers 104. Referring to FIG. 7, the pre-mold 110 sleeve is sized to move axially along the insulated wire 108 into position over the wire/receivers intersection. The premold 110 is typically of a sufficient size such that it may be slid into place with relative ease, but is also of a sufficient elasticity to frictionally hold the wire strands 106 and receivers 104 there-within. Accordingly, the premold 110 provides both mechanical reinforcement and electrical insulation for the contacts and wires.

Once the premold 110 is in place, an over mold 112 is added as an additional layer. An over mold 112 is typically comprised of a flexible material, such as vinyl nitrile or PVC, that is pre-fabricated to fit over the pre-mold 110 and wire assembly. Much like the pre-mold layer 110, the over mold 112 sleeve is sized to move axially along the insulated wire 108 into position over the pre-mold 110. The over mold 112 is typically of a sufficient size such that it may be slid into place with relative ease, but is also of a sufficient elasticity to frictionally hold the pre-mold 110 there-within. This additional layer adds further encapsulation, flex and strain relief, tamper resistance, and, in some cases, resistance to fluids. The over mold 112 may further include a flexible stress/strained relief member 114 integrally molded therein. The flexible stress/strained relief member 114 provides flexible relief with respect to the electrical connection maintained by receivers 104 being coupled to wire strands 106.

Overmolding is a cost effective technology for high volume production. For low and medium volume production, however, it is less attractive for a plurality of reasons. First, the cables cannot be easily reworked. In other words, once the premold 110 and over mold 112 are put into place, the wires cannot easily be disconnected to the contact and rewired to a separate contact. Second, over molding requires mold tools and mold presses. To this end, the manufacturer would have to incur significant start up costs in obtaining the proper manufacturing equipment. These costs can be prohibitive for smaller volume cable assemblies because it would require a longer amount of time to recoup these start up costs. Third, over molded cables have to be factory assembled. This can also add significant costs and delays to production of the cable.

Based on the foregoing, there is a pressing need within the field of electrical, communications and other cables or transmission systems to provide an economically efficient, safe and highly moisture resistant coupling device that will permit the user to easily and quickly connect and disconnect electrical, communication or other lines or devices a plurality of times without compromising system integrity or high moisture resistance with each subsequent reconnection. Furthermore, there is a pressing need within the art for an electrical communication cable that may be easily manufactured with minimal start up costs so as to benefit small and medium volume producers. Finally, there is a pressing need within the art for an electrical communication cable that is able to seal electrical contacts for environmental conditions while allowing an operator to rework the contacts where necessary.

The present invention, as discussed herein, addresses the foregoing needs.

### SUMMARY OF THE INVENTION

The present invention relates to an apparatus and method for protecting the electrical connections within an electrical cable. More specifically, the present invention relates to a cable assembly comprised of a plug and receptacle wherein the receptacle is adapted to mate with and be secured to the plug.

Both the plug and receptacle are each comprised of independent sealing covers containing a plurality of plastic cartridges and electrical contacts. The sealing cover of the plug is comprised of an annularly shaped wall forming a lumen that passes between an open distal end and an open proximal end of the plug. The open distal end of the plug's sealing cover is adapted to receive a plurality of electrical wires, and the open proximal end of the sealing cover is adapted to threadingly or frictionally engage the receptacle and display the electrical contacts. The plug's lumen is sized to contain a first cartridge chamber sized to hold a plurality of first cartridge blocks therein such that the electrical contacts contained within the first cartridge blocks are accessible from both the distal and proximal ends of the sealing cover. Preferably, the cartridge chamber is adapted to receive and frictionally hold four cartridge blocks wherein the cartridges blocks may be bonded together as one unit or separated into four distinct units.

The sealing cover of the receptacle is similarly comprised of an annularly shaped wall forming a lumen passing between an open distal end and an open proximal end of the receptacle. The open distal end of the receptacle's sealing cover is adapted to receive a plurality of electrical wires, and the open proximal end of the sealing cover is adapted to receive the plug by threading or frictional engagement. The receptacle's lumen is sized to contain a second cartridge chamber that holds a plurality of second cartridge blocks therein such that the electrical contacts contained within the first cartridge blocks are accessible from both the distal and proximal ends of the sealing cover. Preferably, the cartridge chamber receives and frictionally holds four cartridge blocks wherein the cartridge blocks may be bonded together as one unit or separable into four discrete units. Most preferably, the plurality of the second cartridge blocks are adapted to mate with the plurality of first cartridge blocks through the open proximal ends of the two sealing covers.

Both the first and second cartridge blocks are of a configuration such that they may be installed within each respective cartridge chamber and interconnected so as to encapsulate the first and second contacts therein. In particular, each cartridge block is polyhedronally shaped with an open distal end and an open proximal end and a lumen passing therebetween. The open proximal end is comprised of a cutaway portion of each cartridge block wherein approximately half of the height of the cartridge block is removed providing a channel in the remaining portion. Preferably, the cartridge blocks, when installed into the plug and receptacle, have opposing cutaway portions exposed at the proximal end of each sealing cover such that, when the plug is mated with the receptacle, the channel of the first cartridge block overlaps the cutaway portion of the second cartridge block and vice versa. Accordingly, when the plug is mated with the receptacle, the two the cartridge blocks overlap to form a single housing.

Contained within each cartridge block is an electrical contact. The electrical contact is sized to fit within the lumen of each cartridge block such that the lumen walls frictionally secure the contact therein. The contacts may also be bonded to the lumen walls so as to further secure the contact within the cartridge blocks. A first end of the contact is accessible through the open distal end of the cartridge block. In a preferred embodiment, the first end of the contact is sized to completely fill the lumen at the distal end of the cartridge block such that the first end of the contact is flush with the distal end of the cartridge block. A second end of the contact is sized to fill the void created in the cut away portion of the proximal end of the cartridge block. Most preferably, the second end of the contact is not within the remaining channel of the proximal end of the cartridge block. Rather, the second end of the contact further defines the remaining channel at the proximal end of the cartridge chamber. Accordingly, the proximal end of each cartridge block is comprised of a contact within the cutaway portion and a channel adjacent to the contact.

The channel created within each cartridge block is adapted to receive the contact of an opposing cartridge block. As noted above, the cartridge blocks of the plug and receptacle have opposing cutaway portions. To this end, they also have opposing contacts to fill the cutaway portions and opposing channels juxtaposed to the contacts. In the most preferred embodiment, each channel is adapted to receive the opposing contact such that, when the plug and receptacle are mated, the channels of each cartridge block receive the opposing contact and overlap with the cutaway portion of the opposing cartridge block. In this configuration, the two electrical contacts of the two opposing cartridge blocks are placed into electrical communication with each other and the two opposing cartridge blocks overlap so as to completely encapsulate the contacts therein.

As noted above, a plurality of cartridge blocks and contacts may be contained with each of the plug and receptacle. Preferably, each of the plug and receptacle are comprised of four cartridge housings wherein each cartridge housing contains one electrical contact. The blocks are installed within the cartridge chamber of each of the plug and receptacle such that the distal end of the cartridge blocks are proximate to the distal end of the sealing cover and the proximal end of the cartridge blocks are proximate to the proximal end of the sealing cover. The four housings are positioned within the lumen of the plug such that the proximal end of each cartridge block interconnects with the proximal end of a similarly placed opposing cartridge block of the receptacle. Accordingly, when the plug and receptacle are mated, each of the four cartridge housings of the plug are independently interconnected so as to overlap with corresponding cartridge housings of the receptacle. Moreover, when the plug and receptacle are mated, the contacts of each of the first cartridge blocks of the plug are placed into electrical communication with the contacts of the corresponding second cartridge blocks of the receptacle

The contacts of both of the plug and the receptacle are independently in electrical communication with a plurality of electrical wires. The wires extend from outside of the respective sealing covers and through the respective distal openings of the sealing covers into each respective cartridge chamber. The wires may be placed into electrical communication with the first end of each contact by way of the open distal end of each cartridge block. The wires may be secured to the contact by any standard method of securing an electrical contact to a wire that is known in the art. In a preferred embodiment, there are four wires extending into each sealing cover wherein each wire is placed into electrical communication with one contact.

The electrical wires may be further secured within the sealing covers of the plug and receptacle by a wiring harness. The wiring harness may be frictionally or threadingly securable within the distal end of the sealing cover with one or more holes adapted to secure the electrical wires to the harness. In the most preferred embodiment, the wiring harness contains at least four holes wherein each hole is adapted to secure one wire to the sealing cover and stabilize the wire so as to prevent the wire from inadvertently dislodging from electrical communication with the contact.

Based on the foregoing, one object of the present invention is to provide a plurality of electrical connections within a plug and receptacle system wherein the electrical connections are completely insulated from environmental conditions.

It is a further object of the present invention to provide a plug and receptacle system wherein, when the plug and receptacle mate, at least two distinct housings encapsulate the electrical connections therein.

It is a further object of the present invention to provide a plug and receptacle system wherein, when the plug and receptacle mate, the electrical connections contained there are encapsulated by overlapping cartridge blocks and the sealing covers of the plug and receptacle.

It is another object of the present invention to provide electrical contacts within a plug and receptacle that may be easily replaced.

It is a further object of the present invention to provide a plurality of electrical contacts within a plug and receptacle that may be replaced individually or as an entire unit.

Additional object and advantages that are apparent to one of ordinary skill in the art are also included as understood from the specification provided herein.

### BRIEF DESCRIPTION OF THE DRAWINGS

FIG. 1 is a schematic representation of an electrical cable according to the present invention.

FIG. 2 is an exploded isometric view illustrating a sealed cover and plastic cartridge package in accordance with the preferred embodiment of the invention.

FIG. 3 is a broken isometric view of the interior of a portion of a sealed cover of a receptacle of the invention.

FIG. 4 is a broken isometric view of the interior of a sealed cover part of the invention together with a plastic cartridge shown therein.

FIG. 5 is a front elevation of the cartridge illustrated in FIG. 4.

FIG. 6 is a schematic representation of a prior art electrical cable wherein a plurality of electrical wires are connected to a contact.

FIG. 7 is a schematic representation of a prior art electrical cable wherein a pre-mold covers the wire/contact connection.

FIG. 8 is a schematic representation of a prior art electrical cable with an over-mold covering the pre-mold and contact/wire connection.

FIG. 9 is a broken isometric view of the interior of a portion of a sealed cover of a plug of the invention.

FIG. 10a and 10b are front and rear views, respectively, of a block of four cartridges.

FIG. 11 is a broken isometric view of the interior of a portion of a sealed cover of a receptacle of the invention wherein one-half of a block of cartridges is contained therein.

### DESCRIPTION OF THE INVENTION

The present invention relates to an apparatus and method for protecting the electrical connections within an electrical cable. More specifically, the present invention is a cable assembly comprised of a plug and receptacle. Both the plug and receptacle are comprised of a sealing cover sized to hold a plurality of plastic cartridges. The plastic cartridges are adapted to retain one or more electrical contacts therein such that the plug is placed into electrical communication with the receptacle when the two are interconnected. To this end, this present apparatus addresses and eliminates the aforementioned problems associated with over-molded electrical connectors.

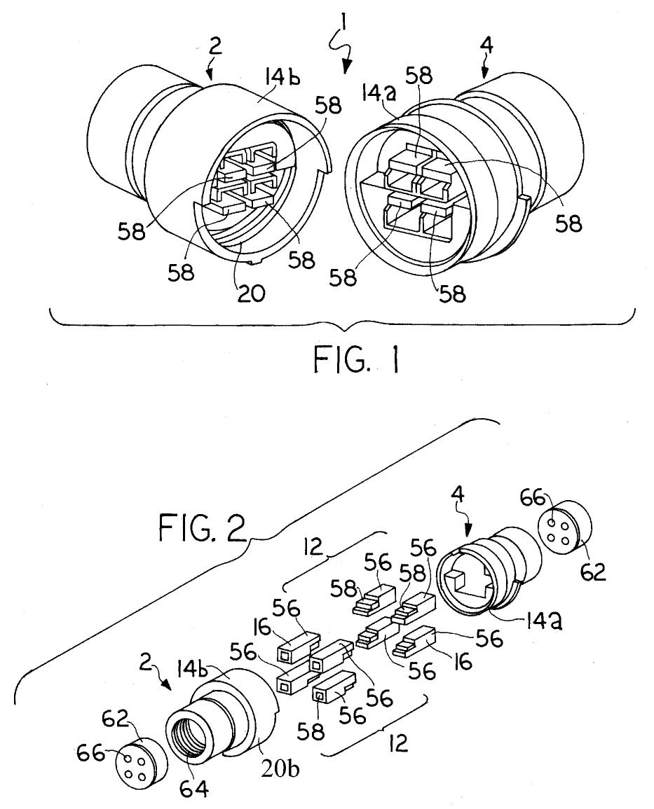

Referring to FIGS. 1 and 2, a cable assembly 1 is illustrated. More specifically, the cable assembly 1 is comprised of a plug 2 and a receptacle 4. As illustrated, both the plug 2 and the receptacle 4 are comprised of independent sealing covers 14 and a plurality of plastic cartridges 16. Each plastic cartridge 16 contains at least one electrical contact 6 wherein each first electrical contact of a plug 2 is adapted to be placed in electrical communication with a corresponding second electrical contact of a receptacle 4. The corresponding contacts 6 when connected, thereby, complete an electrical circuit between the plug and the receptacle, as discussed further herein.

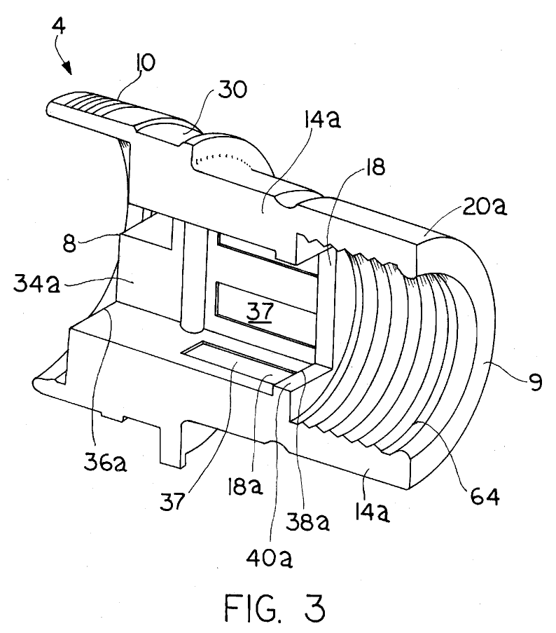

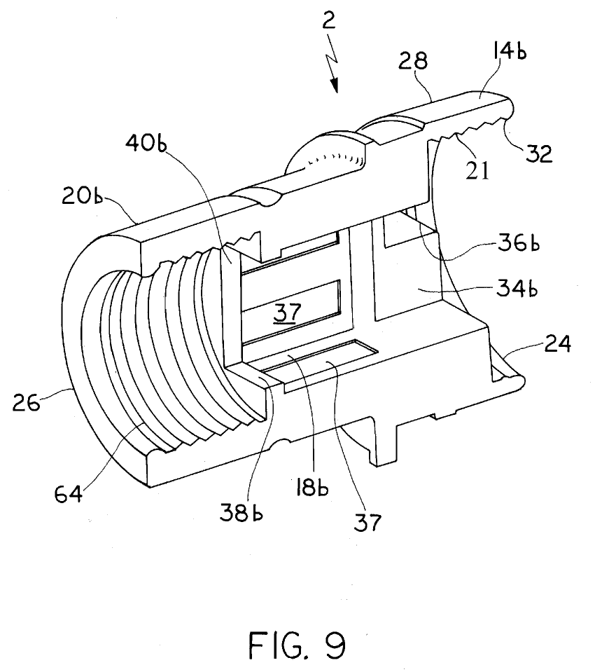

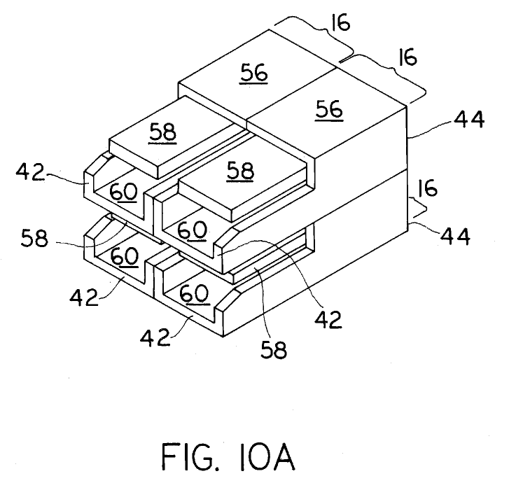

Referring to FIGS. 3 and 9, an annularly shaped sealed cover of the receptacle 4 and plug 2 are illustrated wherein FIG. 3 illustrates the receptacle 4 and FIG. 9 illustrates the plug 2. The sealed covers of both the receptacle and plug 14a, 14b are annularly shaped so as to form annular exterior surfaces 20a and 20b, respectively, and an interior surfaces 18a and 18b, respectively. The sealed cover 14a of the receptacle 4 is substantially cylindrical with hollow cavity formed from the interior surface 18a wherein the hollow cavity passes from an open proximal end 8 of the receptacle to an open distal end 9. Similarly, the sealed cover 14b of the plug 2 is also substantially cylindrical with hollow cavity formed from the interior surface 18b wherein the hollow cavity passes from an open proximal end 24 of the receptacle to an open distal end 26.

The sealed covers 14a 14b are desirably comprised of a soft, flexible, rubber-based material formed from a rubber molding technology that is known in the art. In one embodiment, the sealed covers 14a and 14b are made from a silicone or silicone based rubber. In an alternative embodiment, the sealed covers may also be comprised of a hydrocarbon-based polymeric rubber. For example, the polymeric material may comprised of vinyl nitrile or a vinyl nitrile based material. To this end, any of the forgoing materials, or combinations of the forgoing materials, may be used in the present invention so long as they are consistent with the specifications provided herein. The thickness of the sealed covers 14a, 14b and the hardness of the material used are important for optimal operation. Particularly, the hardness and thickness of the sealed covers 14a, 14b are preferably such that the sealing covers are ridge yet able to expand to fit over a plurality of plastic cartridge blocks 16 or block units 12. Accordingly, the thickness and hardness of the material is balanced to ensure that sealed covers 14a, 14b can be expanded without tearing or stretching on the one hand, but the material must be firm enough to properly cover the plastic cartridge blocks 16 and remain in place.

The proximal end 24 of the plug's sealed cover 14b is preferably sized so as to concentrically fit over the proximal end 8 of the receptacle's sealed cover 14a such that the receptacle 4 may be lockingly engaged by the plug 2. In one embodiment, a plurality of ridges 10 are present on the outer surface 20a of the receptacle 4, preferably at or near the proximal end 8 of the receptacle 4. The ridges 10 are adapted to frictionally engage a plurality of corresponding ridges 20 in an aspect of the interior surface 18b of the plug 2, preferably, at or near the proximal end 24 of the plug 2. Specifically, the ridges 20 may be on an interior surface of an annular collar 28 of the plug 2 wherein the collar 28 is integrally formed with the proximal end 8 of the plug 2 and has a diameter slightly larger than the body of the plug 2. Preferably, the collar 28 is sized so as to fit over the proximal end 8 of the receptacle 4 such that the ridges 10, of the receptacle and plug, respectively, can frictionally engaged one another. Accordingly, upon mating the plug 2 with the receptacle 4 the frictional engagement between the ridges 10, 20 functions to secure the plug to the receptacle and isolate the electrical connection from environmental conditions.

In an alternative embodiment, the plurality of ridges 10, 20 represent threads. The threads 10 of the receptacle 4 are adapted to threadingly engaged the corresponding threads 20 of the collar 28. In this embodiment, the collar 28 may be adapted to rotate independently of the of the plug 2 and about the plug's longitudinal axis. The collar 28, therefore, may be coupled to the plug 2 by way of a bearing or other similar device to allow for rotation of the collar 28 without affecting the body of the plug 2. Upon mating the plug 2 with the receptacle 4, the collar 28 threadingly engages the threads 10 proximal end 8 of the receptacle 4 by independently rotating about the longitudinal axis of the plug 2 and, thereby, lockingly engaging the plug to the receptacle.

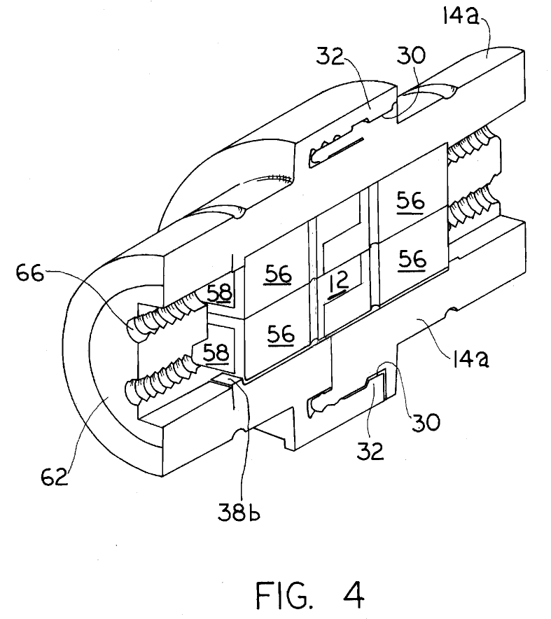

In a further embodiment, either in conjunction with or in place of the previous embodiments, the proximal end 24 of the plug 2 may snap fit into the proximal end 8 of the receptacle 4. More specifically, as illustrated in FIG. 3, the proximal end 8 of the receptacle may contain a recess 30 about the exterior cover 20a of the receptacle wherein the recess 30 is preferably distal to the ridges/threads 10. The recess 30 corresponds with a large, annular ridge 32 extending about the proximal end 24 of the plug on the interior surface 18b. Preferably, the ridge 32 extends along the interior surface of collar 28 in proximally from the ridges/threads 20. As illustrated in FIG. 4, when the collar 28 of the plug 2 engages the proximal end 8 of the receptacle 4 the plug's larger ridge 32 fits into the receptacle's recess 30, thereby, further frictionally securing the plug to the receptacle.

Referring to FIGS. 3 and 9, spaced between the proximal end and distal end of both the sealing covers of the receptacle and plug are cartridge retaining chambers 34a, 34b. Both cartridge retaining chambers 34a and 34b are formed from the interior sides 18a and 18b of the receptacle and plug, respectively, and are sized to receive and secure a plurality of electrical contact containing cartridge blocks 16. In both the plug and the receptacle, chambers 34b and 34a may be rectangularly shaped with a first open end and a second open end. In the plug, the first open end 36b leads to the proximal end 24 of the plug, while the second open end 38b leads to the distal end 26 of the plug. Similarly, in the receptacle, the first open end 36a leads to the proximal end 8 of the receptacle, while the second open end 38a leads to the distal end 9 of the receptacle. Referring to FIG. 9, the perimeter of second open end 38b of the plug 2 is formed by a retaining wall 40b such that the size of the second open end 38b is smaller than the size of both the first open end 36b and the cartridge retaining chamber 34b. The retaining wall 40b, thereby, provides a rear stopping position for the cartridge blocks 16 inserted into the plug through its proximal end 24, as illustrated in FIGS. 4 and 11. The retaining wall 40b, however, is sized to leave an opening at the distal end of the retaining chamber 34b such that each of the cartridge blocks 16 are accessible through the distal end 26 of the plug. Similarly, referring to FIG. 3, the perimeter of second open end 38a of the receptacle 4 is formed by a retaining wall 40a such that the size of the second open end 38a is smaller than the size of both the first open end 36a and the cartridge retaining chamber 38b. To this end, the perimeter of the retaining wall 40a provides a rear stopping position for the cartridge blocks 16 within the receptacle. The retaining wall 40a, however, is sized to leave an opening at the distal end of the retaining chamber 34a such that each of the cartridge blocks 16 within the receptacle 4 are accessible through the distal end of the receptacle.

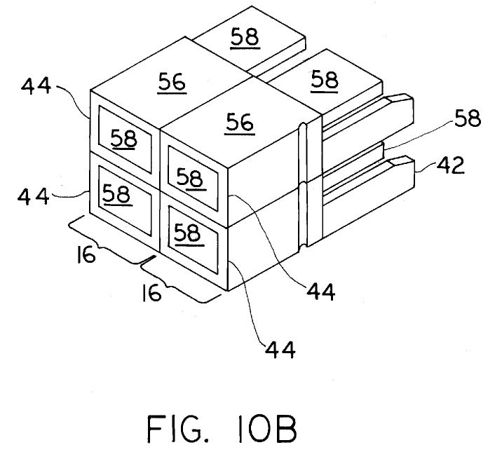

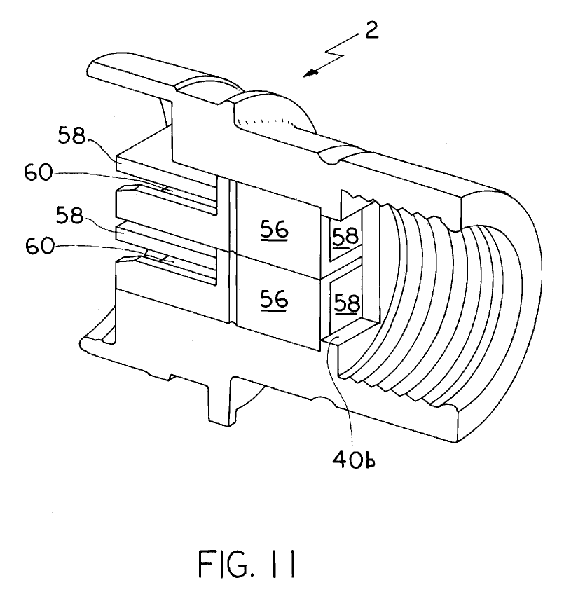

Referring to FIGS. 2, 10a and 10b, a plurality of cartridge blocks 16 of the present invention are illustrated as each comprising a housing member 56 and an electrical contact 58 within the housing. In one embodiment, the housing 56 of each cartridge block 16 may be comprised of nylon or polycarbonate polymer that is molded into a polyhedronally shape, preferably in the form of a hexahedron or similar structure, with a hollow cavity or lumen contained therein. The hollow cavity passes from a proximal end 42 of the housing 56 to the distal end 44 of the housing so as to create an opening at each proximal and distal end. The opening in the distal end 44 of housing 56 is substantially squared in shape so as to mimic the shape of the housing. However, the present invention is not limited to this embodiment, and the opening at the distal end 44 may be of any shape so long as the electrical contact secured within the housing 56 is accessible therethrough.

The hollow cavity also leads an opening at the proximal end 42 of the housing 56. More specifically, in one embodiment the opening may be similar to that of the distal end 44 of the housing 56 in that it mimics the shape of the housing. Preferably, however, a portion of the proximal end 42 of the housing 56 is removed or cut away. Referring to FIG. 10A, a plurality of cartridge blocks are illustrated wherein the top half portion of the proximal end 42 of the housing is removed such that the lower half of the proximal end 42 forms a substantially U-shaped channel 60. This configuration creates an open channel 60 at the lower half of the proximal end 42 and an open space or void at the upper half. As illustrated in FIG. 1, however, the housing 56 is not limited to this configuration and may be in an opposing or reversed configuration wherein the lower half portion of the cartridge block may be removed creating a void and leaving a channel 60 in the upper half of the housing. To this end, these opposing configurations of cartridge blocks may be arranged within a plug and receptacle such that the cut away portion of a first cartridge block receives the channel portion of an opposing second cartridge block and vice versa.

The hollow cavity of the housing 56 is adapted to receive and secure an electrical contact 58 therein. More specifically, the contact is shaped so as to substantially mimic the interior cavity of the housing 56, especially with respect to the distal end of the housing 56. In a preferred embodiment, the contact 58 is formed such that it is polyhedronally shaped, preferably in the form of a hexahedron or similar structure with a distal end and a proximal end. The distal end of the contact 58 is illustrated in FIG. 10B as substantially squared in shape so as to mimic the hollowed cavity of the housing wherein the distal end of the contact is accessible through the distal end 44 of the housing 56. To this end, the distal end of the contact may be frictionally secured to the interior walls of the housing 56 or bonded thereto with a glue or similar bonding agent.

The proximal end of the contact 58, as illustrated in FIG. 10A, is adapted to fill void created in the cut away portion of the proximal end 42 of the housing 56 and further define the channel 60. More specifically, the perimeter of the proximal end of the contact 58 is smaller than that of the distal end. Preferably, the perimeter of the proximal end of the contact is approximately half that of the distal end such that a portion the proximal end of the contact 58 appears removed or cut away. Most preferably, the proximal end of the contact 58 is sized to extend into and substantially fill the void created in the cut away portion of the housing 56. However, the proximal end of the contact 58 does not interfere with the channel 60 of the housing 58; rather, the proximal end of the contact 58 extends parallel to the channel 60 so as to provide a channel boundary. As described further herein, in this configuration, the channel 60 and contact 58 cooperate in receiving a contact from an opposing cartridge block wherein the opposing contact is received into the channel 60 and placed into electrical communication with contact 58.

The plurality of foregoing cartridge blocks 16 may be individually inserted into the chambers 34a and 34b of the receptacle and plug such that the blocks 16 are held in place by the frictional engagement therebetween and by the interior walls of the cartridge chambers. More specifically, the chambers 34a and 34b are sized to fit a plurality of cartridges such that the contact portion of each cartridge is exposed at or about the proximal ends of the plug and receptacle. Most preferably, as illustrated in FIGS. 1 and 2, the chambers 34a and 34b are each sized to fit four cartridges blocks 16. The area of each chamber 34a and 34b is, therefore, approximately the same, or slightly smaller, as the area of the four cartridge blocks 16 such that the chamber 34a and 34b may frictionally secure the cartridge blocks 16 therein. The chambers 34a and 34b may be further shaped so as to secure the cartridges by using one or more alignment features wherein the alignment features provide mechanical strength to secure the sealed cover to the plastic cartridge blocks 16. Such alignment features may include, but are not limited to a plurality of recesses 37 spaced about the periphery of the chambers 34a and 34b. Each recess may correspond with a similarly sized ridge (not illustrated) or spring on the body of the cartridges 16. In other words, features molded into the chambers 34a and 34b of the sealed covers 14a and 14b match features on the plastic cartridge blocks 12. This alignment enables the cartridge blocks 16 to be secured within the chambers 34a and 34b and prevents the parts from separating under normal use.

In a preferred embodiment, the plurality of blocks may be bonded together prior to installation so as to form a singular block unit 12. This singular block unit 12 facilitates aligning the cartridge blocks 16 with the alignment features of the cartridge chamber and has the added advantage of facilitating installation and/or replacement of the electrical connections within the cable assembly. Accordingly, one can easily install, remove and/or replace the contact of a plug or receptacle by the removal and/or installation of the singular block unit 12. Referring again to FIGS. 10a and 10b, and in accordance with the above, four cartridge blocks 16 may be bonded together so as to form a single block unit 12 wherein a first block unit 12 may received within chamber 34a of the receptacle 4 and an opposing second block unit 12 may be received within chamber 34b of plug 2. Preferably, referring to FIG. 1, the block units are installed into the plug and receptacle such that similarly placed the cartridge blocks are positioned in opposition to each other so as to facilitate the electrical connectivity between the contacts of the plug 2 and the receptacle 4. For example, as illustrated in FIG. 1, the block unit 12 of a receptacle 4 may be oriented such that the channel 60 at the proximal end 42 of each housing 56 is beneath the contact 58. Conversely, the block unit 12 of the plug 2 is oriented such that the channel 60 at the proximal end 42 of each housing 56 is above the contact 58 extending into the void of the housing 56. Accordingly, when the plug and the receptacle mate, each respective contact is received into the channel of the opposing housing. The two opposing contacts are, thereby, placed into electrical communication with each other and insulated from environmental conditions by way of the overlapping and opposing housings 56.

The structure of the cartridge blocks and the contacts above are not limiting to the structure of the invention. Rather, the mold of the cartridge blocks and the contacts therein may be in any form known in the art for establishing electrically communication. In any of these forms, however, it is preferred that the connectivity be contained completely within the interlocking blocks such, once interconnected, the blocks shield the contacts from environmental conditions.

Each contact 58 of each cartridge block is also in electrical communication with one or more wires extending into the sealing cover by way of its distal end. Preferably, the contact is in electrical communication with the wiring by way of the opening in the distal end of the housing 56. Referring to FIGS. 4 and 11, in one embodiment, the wiring extends into and through the distal end of the sealing covers 14b, 14a in each of the plug 2 and the receptacle 4 such that it is coupled to the contacts 58 at the distal end of the cartridge block housing 56. The wiring may be coupled to the contacts by any method understood in the art to secure an electrical wire to and electrical contact. In one embodiment, the wiring may be soldered to the contact. In another embodiment, the wiring may be crimped to an extension of the contact. The wiring may also be secured to the contact by any similar method known in the art for maintaining an electrical connection between the contact and the wiring.

In one embodiment, the wires extend into the sealing cover through a wiring harness 62 mounted within the distal end of the sealing covers. Specifically, the wiring harness 62 is sized to fit within the distal end of the hollow cavity of the plug and receptacle. As illustrated in FIGS. 2 and 4, the wiring harness 62 may be cylindrical in shape with a plurality of holes passing therethrough. The holes are sized to support wiring therethrough and may contain a plurality of ridges to frictionally engaged insulation around the wiring. In one embodiment, the wiring harness 62 may be secured within the hollow cavity of the sealing cover by a plurality of ridges. The ridges 64 may be adapted to frictionally engage the wiring harness 62 so as to frictionally hold it in a plane perpendicular to the longitudinal axis of the sealing cover. Alternatively, the ridges may be adapted to threadingly engage the wiring harness 62 so as to secure it within the sealing cover. The wiring harness is not limited to the foregoing embodiments and may be in any similar configuration to secure the wiring to the sealing cover and maintain the connection between the wiring and the contacts.

In operation, the contact 58 of each cartridge block 16 is placed into electrical communication with a wire in accordance with the above and the cartridge blocks 16 or block units 12 are secured within each of the plug 2 and receptacle 4. The frictional engagement of the cartridge blocks 16 with the interior walls of the respective cartridge chambers and the alignment features 37 serve the secure all of the cartridge blocks therein so as to display the proximal end of each cartridge block 16 and contact 58 at the proximal ends of the plug 2 and receptacle 4. Moreover, bonding the cartridge blocks into discrete units 12 facilitates the installation and removal of the cartridge blocks into and out of the sealing covers.

As illustrated in FIGS. 1 and 11, the cartridge blocks 16 are positioned within the plug and receptacle such that the distal end of each cartridge block abuts the retaining walls 40a, 40b and electrical wiring, extending into the distal end of the sealing covers, may be coupled to the distal end of each contact. To prevent the wiring from separating from the distal end of the contact the wiring is further secured to the sealing covers 14a, 14b, by way of the wiring harness 62.

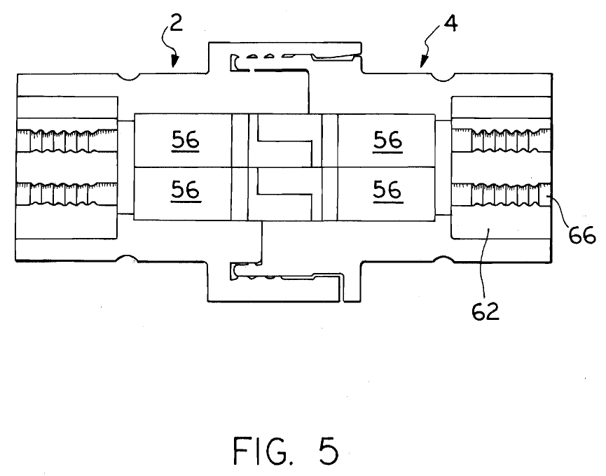

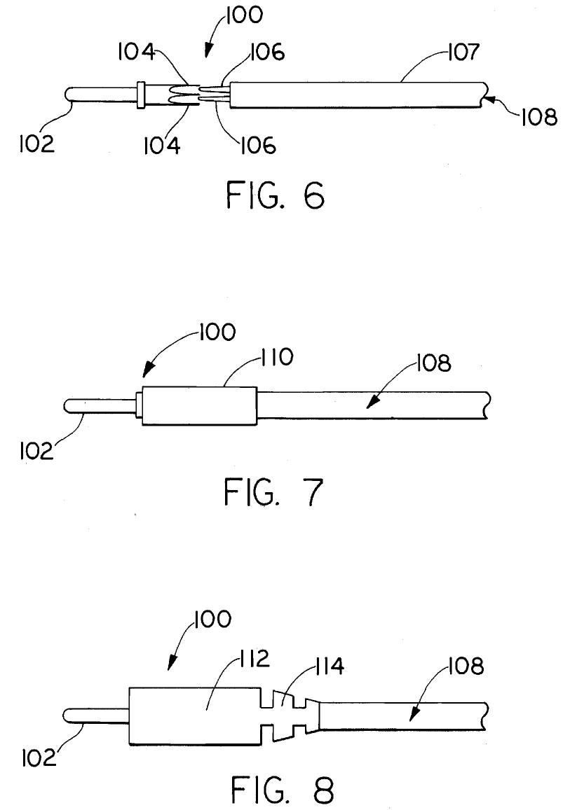

As noted above, each of the cartridge the blocks 16 within the plug 2 represent interlocking halves with each of the cartridges blocks 16 of the receptacle 4. To this end, when installed, the cartridge blocks of the plug are positioned in an inverted orientation to those of the receptacle such that the channels of each cartridge block 16 of the plug 2 receive the contacts of the cartridge blocks 16 of the receptacle 4 and vice versa. Referring to FIG. 5, when the plug and receptacle are connected, the electrical contacts of the plug 2 and receptacle 4 are received by the channels of the opposing cartridge blocks and are placed into electrical communication therewithin. More importantly, when the plug and receptacle are mated, the housings 56 within the plug and receptacle completely overlap such that both contacts are completely encased within the overlapping housings. Thus, the overlapping cartridge blocks of the plug and receptacle provide a first insulative layer for the electrical contact between the plug and receptacle. A second insulative layer is provided the sealing covers 14a and 14b wherein, when the plug and receptacle are mated together, the respective sealing covers interconnect in accordance with the above so as to isolate the cartridge blocks from environmental conditions.

Based on the foregoing, the present invention is advantageous because it provides a plurality of electrical connections within a plug and receptacle system wherein the electrical connections are completely insulated from environmental conditions. More specifically, the housing 56 surround each contact in the plug and receptacle mate such that the housing, in combination, completely surround and encase the electrical connection therein. This connection is further protected by way of the sealing covers of the plug and receptacle, which also overlaps so as to isolate the housings and electrical connections from environmental conditions.

The present invention is additionally advantageous because the electrical connections of both the plug and receptacle may be easily replace. Specifically, one desiring to replace an electrical contact can easily remove a cartridge block 16 or cartridge unit 12 from a sealing cover. Replacing the cartridge block 16 or unit 12 involves nothing more than securing the block 16 or unit 12 to the wiring and reattaching it within the sealing cover. Accordingly, replacement of the electrical contact is relatively simple.

Additional advantages that are apparent to one of ordinary skill in the art are also included herein.

The following is claimed:

1. An electrical cable assembly comprising:
a first sealing cover comprising:
an annularly shaped wall forming a lumen that passes between an open distal end and an open proximal end of the first sealing cover;
at least one first cartridge block secured within the lumen of the first sealing cover wherein the first cartridge block displays at least one first electrical contact, which is in electrical communication with at least one electrical wire, at the proximal end of the first sealing cover; and
a second sealing cover comprising:
an annularly shaped wall forming a lumen that passes between an open distal end and a proximal end;
at least one second cartridge block secured within the lumen of the second sealing cover wherein the second cartridge block displays a second electrical contact, which is in electrical communication with at least one electrical wire, at the proximal end of the second sealing cover;
wherein the first sealing cover mates with the second sealing cover such that the first electrical contact is placed into electrical communication with the second electrical contact and the first cartridge block and second cartridge block interconnect so as to completely encapsulate both the first electrical contact and the second electrical contact therein.

2. The electrical cable assembly of claim 1 wherein the first sealing cover is comprised of a plug and the second sealing cover is comprised of a receptacle.

3. The electrical cable assembly of claim 1 wherein the plurality of first cartridge blocks are frictionally secured within the lumen of the first sealing cover by a plurality of interior walls of the lumen of the first sealing cover and the plurality of second cartridge blocks are frictionally secured within the lumen of the second sealing cover by a plurality of interior walls of the lumen of the second sealing cover.

4. The electrical cable assembly of claim 1 wherein the plurality of first cartridge blocks are comprised of four first cartridge blocks and the plurality of second cartridge blocks are comprised of four second cartridge blocks.

5. The electrical cable assembly of claim 4 wherein the four first cartridge blocks are bonded together as a single unit and the four second cartridge blocks are bonded together as a single unit.

6. The electrical cable assembly of claim 1 wherein each first cartridge block displays the first electrical contact within a region cut away from the first cartridge block forming a first channel within each first cartridge block that is juxtaposed to the first contact and wherein each second cartridge block displays the second electrical contact within a region cut away from the second cartridge block forming a second channel within each second cartridge block that is juxtaposed to the second contact.

7. The electrical cable assembly of claim 6 wherein the second contact of the second cartridge block is receivable within the first channel of the first cartridge block and the first contact of the first cartridge block is receivable within the second channel of the second cartridge block, thereby, placing the first contact and the second contact in electrical communication when the first sealing cover and the second sealing cover are mated.

8. The electrical cable assembly of claim 7 wherein the first channel of the first cartridge block is sized to be approximately the same as the cut away region from the second cartridge block and the second channel of the second cartridge block is sized to be approximately the same as the cut away region of the first cartridge block such that, when the first sealing cover is mated with the second sealing cover, the first channel overlaps with the cutaway region of the second cartridge and the second channel overlaps with the cutaway region of the first cartridge such that the first and second contacts are completely encased within the first cartridge and the second cartridge.

9. The electrical cable assembly of claim 1 wherein the first electrical contact is in electrical communication with at least one electric wire through an opening at a distal end of the first cartridge and the distal end of the first sealing cover and the second electrical contact is in electrical communication with at least one independent electric wire through an opening at a distal end of the second cartridge and the distal end of the second sealing cover.

10. The electrical cable assembly of claim 1 wherein the electrical wire in electrical communication with the first electrical contact is further secured to the first sealing cover by a first wiring harness coupled to the distal end of the first sealing cover and the independent electrical wire in electrical communication with the second electrical contact is further secured to the second sealing cover by a second wiring harness coupled to the distal end of the second sealing cover.

11. The electrical cable assembly of claim 10 wherein the first wiring harness is coupled to the distal end of the first sealing cover through frictional engagement of the first wiring harness with a plurality of ridges extending from the lumen at the distal end of the first sealing cover and the second wiring harness is coupled to the distal end of the second sealing cover through frictional engagement of the second wiring harness with a plurality of ridges extending from the lumen at the distal end of the second sealing cover.

12. The electrical cable assembly of claim 10 wherein the first wiring harness is coupled to the distal end of the first sealing cover through a threading engagement of the first wiring harness with a plurality of ridges extending from the lumen at the distal end of the first sealing cover and the second wiring harness is coupled to the distal end of the second sealing cover through a threading engagement of the second wiring harness with a plurality of ridges extending from the lumen at the distal end of the second sealing cover.

13. The electrical cable assembly of claim 1 wherein the first sealing cover frictionally engages the second sealing cover.

14. The electrical cable assembly of claim 1 wherein the first sealing cover threadingly engages the second sealing cover.

15. An electrical cable assembly comprising:
a first sealing cover comprising:
an annularly shaped wall forming a lumen that passes between an open distal end and an open proximal end of the first sealing cover;
a plurality of first cartridge blocks secured within the lumen of the first sealing cover wherein each of the plurality of first cartridge blocks is displays a first electrical contact at an opening at a proximal end of each of the plurality of first cartridge blocks so as to form a first channel substantially between each first electrical contact and each first cartridge block and each of the first electrical contacts is in electrical communication with an electrical wire through an opening at a distal end of each of the plurality of first cartridge blocks wherein each of the plurality of first cartridge blocks is secured within the lumen of the first sealing cover such that the opening at the distal end of each of the plurality of first cartridge blocks is proximate to the open distal end of the first sealing cover and the opening at the proximal end of each of the plurality of first cartridge blocks is proximate to the open proximal end of the first sealing cover; and
a second sealing cover comprising:
an annularly shaped wall forming a lumen that passes between an open distal end and a proximal end;
a plurality of second cartridge blocks secured within the lumen of the second sealing cover wherein each of the plurality of second cartridge blocks is displays a second electrical contact at an opening at a proximal end of each of the plurality of second cartridge blocks so as to form a second channel substantially between each second electrical contact and each second cartridge block and each of the second electrical contacts is in electrical communication with an electrical wire through an opening at a distal end of each of the plurality of second cartridge blocks wherein each of the plurality of second cartridge blocks is secured within the lumen of the second sealing cover such that the opening at the distal end of each of the plurality of second cartridge blocks is proximate to the open distal end of the second sealing cover and the opening at the proximal end of each of the plurality of second cartridge blocks is proximate to the open proximal end of the second sealing cover;
wherein the first sealing cover mates with the second sealing cover such that each of the first electrical contacts are received within the second channels and each of the second electrical contacts are received within the first channels such that the first electrical contacts are placed into electrical communication with the second electrical contacts, wherein each of the plurality of first cartridge blocks mates with each of the plurality of second cartridge blocks so as to completely encapsulate both the first electrical contact and the second electrical contact therein, wherein the first sealing cover and the second sealing cover mates such that each of the plurality of first cartridge blocks and each of the plurality of second cartridge blocks are completely encapsulated therein.

16. An electrical cable assembly comprising:
a plug comprising:
an annularly shaped wall forming a lumen that passes between an open distal end and an open proximal end wherein the open distal end displays a plurality of electrical contacts and the open proximal end receives a plurality of electrical wires in electrical communication with the first electrical contact;
four first cartridge blocks, each having one of the plurality of first electrical contact secured therein, secured within the lumen of the plug wherein a proximal end of each of the first cartridge blocks display each of the first contacts and form a channel between each of the first contacts and at least one wall of the cartridge blocks and a distal end of each of the first cartridge blocks places each of the first electrical contacts in electrical communication with one of the plurality of electrical wires; and
a receptacle comprising:
an annularly shaped wall forming a lumen that passes between an open distal end and an open proximal end wherein the open distal end displays a plurality of second electrical contacts and the open proximal end receives a plurality of electrical wires in electrical communication with the second electrical contact;
four second cartridge blocks, each having one of the plurality of second electrical contacts secured therein, secured within the lumen of the plug wherein a proximal end of each of the second cartridge blocks display each of the second contacts and form a channel between each of the second contacts and at least one wall of the second cartridge blocks and a distal end of each of the second cartridge blocks places each of the second electrical contacts in electrical communication with one of the plurality of electrical wires;
wherein the plug mates with the receptacle such that each of the first electrical contacts of the plug are received within one of the second channels of the receptacle and each of the second electrical contacts of the receptacle are received within one of the first channels of the plug such that each of the first electrical contacts are placed in electrical communication with at least one of the second electrical contacts, wherein each of the plurality of first cartridge blocks mates with each of the plurality of second cartridge blocks so as to completely encapsulate both the first electrical contact and the second electrical contact therein, wherein the first sealing cover and the second sealing cover mates such that each of the plurality of first cartridge blocks and each of the plurality of second cartridge blocks are completely encapsulated therein.
